(19) United States
(12) Patent Application Publication
(10) Pub. No.: US 2021/0239091 A1
(43) Pub. Date: Aug. 5, 2021

(54) MACHINE HAVING A FLETTNER ROTOR AND WORKING METHOD FOR THE MACHINE

(71) Applicant: Robert Penn, Eichenau (DE)

(72) Inventor: Robert Penn, Eichenau (DE)

(21) Appl. No.: 15/999,731

(22) PCT Filed: Feb. 20, 2017
(86) PCT No.: PCT/EP2017/053784

§ 371 Date: Sep. 17, 2018

(30) Foreign Application Priority Data
Feb. 18, 2016 (EP) 16156404-2

(51) Int. Cl. F03D 3/00; F03D 1/06

(52) U.S. Cl. CPC F03D 3/007; F03D 13/20; F03D 1/0616

(57) ABSTRACT

The invention relates to a device, having at least one rotor, which has an axis of symmetry with respect to which the rotor is rotationally symmetrical and which is rotationally motor-driven about the axis of symmetry of the rotor and which is mounted for rotation about an axis of rotation arranged transverse to the axis of symmetry such that, in the event of incident flow of a fluid, the rotor is rotationally driven in a rotational motion about the axis of rotation by means of a force acting transversely to the fluid flow. Said device enables the production of a rotational motion when the rotor is translationally driven in the fluid relative to the fluid in the longitudinal direction of the axis of rotation.

### TECHNICAL FIELD

The invention concerns a device for generating a rotary movement by means of a Flettner rotor.

### STATE OF THE ART

A Flettner rotor is understood as a rotor dating back to Anton Flettner. The Flettner rotor is rotationally symmetrical with respect to its axis of rotation and is exposed to a fluid flow whose direction of flow is orthogonal to the axis of rotation, or has at least one non infinitely orthogonal component. Flettner thus made use of the “Magnus effect” named after the physicist Heinrich Gustaf Magnus. The Magnus effect is a transverse force acting on the Flettner rotor rotating in the flow. The transverse force acts essentially orthogonal to the flow and the axis of rotation. The Flettner rotors were used in shipping as sails, to generate lift in aircrafts and also as wind turbines (Anton Flettner: Mein Weg zum Rotor, Köhler & Amelang, Leipzig 1926).

### DESCRIPTION OF THE INVENTION

It is the object of the invention to provide a rotary drive with a Flettner rotor and a corresponding working method.

The object is solved by a device according to the independent claim, and by an appropriate method, respectively.

The device has at least one rotor with a symmetry axis. The rotor is rotationally symmetrical with respect to its axis of symmetry, preferably continuously rotationally symmetrical. Continuously rotation symmetrical here means that the rotor is projected onto itself when rotated about any angle around the axis of symmetry. The rotor is rotationally driven around its axis of symmetry. For this purpose, for example, it can be mounted on a rod rotatable around its axis of symmetry by means of at least one first bearing and it can be driven by a motor, preferably an electric motor. The rotor is also mounted to rotate about a second axis, which is designated as axis of rotation, wherein the rotor is preferably located at a distance from the axis of rotation. In the example of the rotor mounted rotatable on the rod, the rod would be mounted rotatable about the second axis. The axis of rotation is oriented at least approximately transversely to the axis of symmetry in space, so that when the rotor moves along the axis of rotation in a fluid, a transverse force component acting on the rotor sets it into rotation about the axis of rotation. Only for the sake of good order it should be pointed out again, that the term rotation axis here refers to the second axis and not to the axis of symmetry of the rotor, about which the rotor is rotationally driven. Accordingly, the axis of symmetry could also be called the first axis.

To allow that the rotor rotates accordingly about the second axis (=axis of rotation), it is displaced by means of another drive in a fluid along the axis of rotation. Strictly speaking, it is sufficient if the movement vector of the displacement has a component that does not disappear in the longitudinal direction of the axis of rotation. This should only be meant for linguistic simplicity when talking about a translation of the rotor along the axis of rotation. The other drive can be again an electric drive, for example.

Preferably the rotor is positively driven, so that the second axis (=the axis of rotation) rotates at least temporarily during the translation. This can be achieved, for example, by guiding the bearing, which allows for a rotation about the second axis (hereafter “second bearing”), on a track. Preferably the guide track guide describes a closed curve, i.e. the second bearing is guided on a closed and preferably continuously curved curve. In the simplest case, the second bearing can sit, for example, in a bogie, so that the curve is a circular path. Then the second bearing rotates on a circular path. The longitudinal direction of the axis of rotation is then defined by the tangent at the corresponding location. If the second bearing is guided on a circular path, the longitudinal axis of the rotor rotates about the circular path. Consequently, the inner and the outer end of the rotor each describe a rotational torus (annular torus). In this case, the longitudinal direction of the axis of rotation in the fluid rotates about a fixed axis.

Of course, oval, non-planar or other curves are also possible. Also with such curves the longitudinal direction of the rotation axis is given by the corresponding tangent. The rotation of the longitudinal direction of the axis of rotation within space should preferably be steady, such that a steadily bended track curve results. At a discontinuous bended curve, the translation at the place of the kink would disappear, and the transverse force acting on the rotor would become very small. In particular, if two or more rotors rotate in one plane about the axis of rotation, this would cause the rotors on the inner side of the curve to receive flow in the opposite direction. The usable torque caused by the transverse force is correspondingly reduced.

As described above, by means of the translation of the rotor, which is driven in rotation about its longitudinal axis, a transverse force in the fluid is generated, resulting in a torque which results in a rotation of the rotor about a second axis. This rotation can serve various purposes, for example to drive a generator. The electrical energy generated in this way can be used for a for a variety of purposes, for example for operating electrical lamps which can be arranged on the rotor. The electrical energy can be fed back as operating power either for the translational drive and/or for the rotational drive of the rotor. Alternatively, the mechanical power of the rotor can be used as such.

### DESCRIPTION OF THE DRAWINGS

The invention is described below by means of exemplary embodiments under with reference to the drawings as an example without limiting the general idea of invention.

FIG. 1 shows a device according to the invention

FIG. 2 shows the device according to FIG. 1.

FIG. 3 shows a variant of the device according to FIG. 1 in top view.

FIG. 4 shows another device according to the invention.

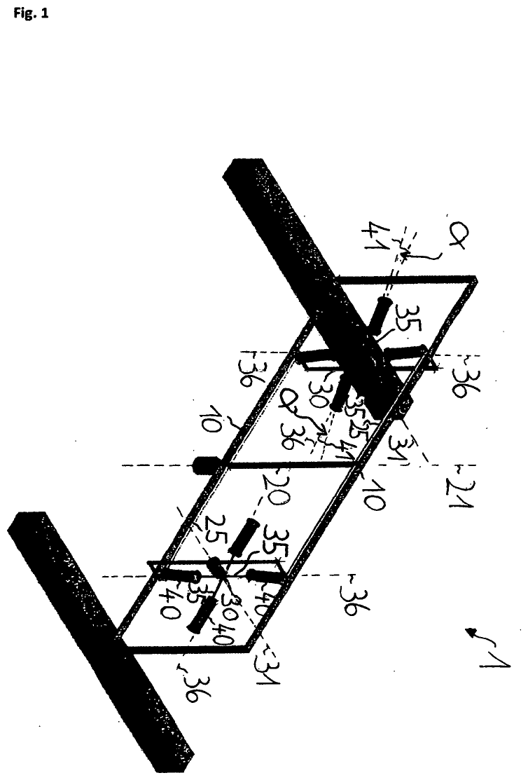

FIG. 1 shows a device 1 according to the invention. The device 1 has an e.g. frame-like carrier 10 which rotatably carries a drive shaft 20. The drive shaft 20 is driven by a motor 11 mounted on the carrier 10. A bogie 25 is attached to the drive shaft 20, said bogie being accordingly driven by the motor 11. At each of the two radially outward facing end areas of the bogie 25 there is a so-called second bearing 30 which allows rotation of rods 35 in a radial plane relative to the drive shaft 20. At the rods 35 there is respectively one rotor 40 spaced from the second axis 31. The rotor 40 is rotationally symmetrical to its longitudinal axis 41, which is also called first axis 41. The rotors 40 are rotatably driven about their respective longitudinal axes, all with the same direction of rotation. The longitudinal axis 41 is angled relative to the radial direction with respect to the second axis 31 (=rotation axis) preferably as shown in the example by a small angle α (0≤α≤15°, but preferably lies in a radial plane relative to the second axis, i.e. in the same plane as the radial axes 36, and preferably also in a plane radial to the drive shaft 20.

When the motor 11 is started up, it drives the rotation of the bogie 25 and with it the rotors 40 that rotate about their respective longitudinal axis, which consequently also rotate with the drive shaft about the drive axis 21. As a result, the rotors 40 are subjected to the flow in the fluid surrounding the device, for example the air, because they are displaced in the longitudinal direction of the axis of rotation 31, i.e. they are subject to a translation in the fluid. At the same time, i.e. during the translation of the second bearings 30, the rotation axes 31 are also rotated about an axis running parallel to the drive axis 21 through the bearing 30, by means of the restricted guidance of the bogie in the example. As a result, the direction of the axes of rotation relative to the carrier changes. The incident flow of the rotors 40 rotating about their longitudinal axis causes a transverse force known as the Magnus effect. This transverse force acts as torque on the rods 35 and sets them into rotation about the rotation axis 31 (=second axis). The corresponding drive power can be used in almost any way, for example a generator can be arranged in the bearing.

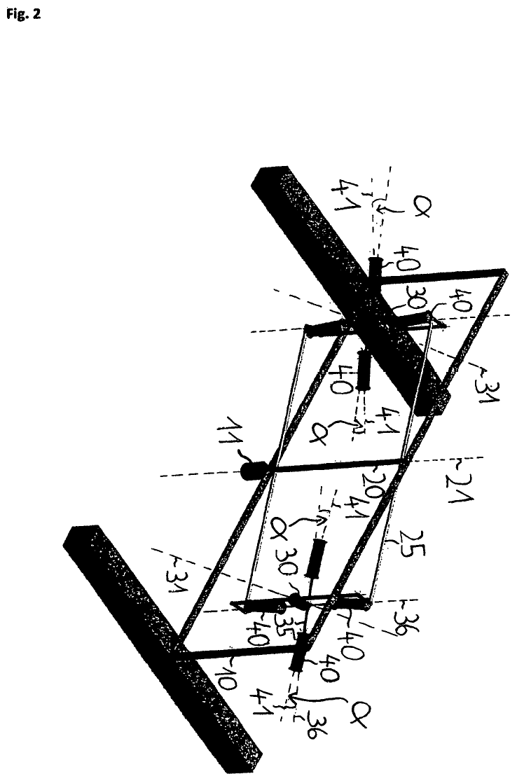

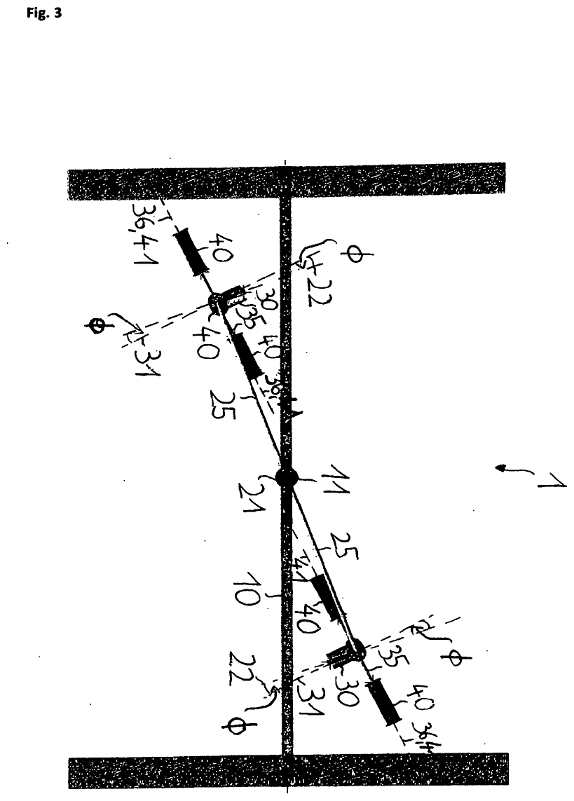

FIGS. 2 and 3 show the same device but the bogie is shown slightly rotated about the drive axis. The description of FIG. 1 can therefore also be read on FIGS. 2 and 3. In FIG. 3, the rotation axis 31 is tilted by a small angle ø(0≤ø≤15°) against the tangential 22 of the circular path of bearing 30. The two axes 36 and 41 coincide when viewed from above.

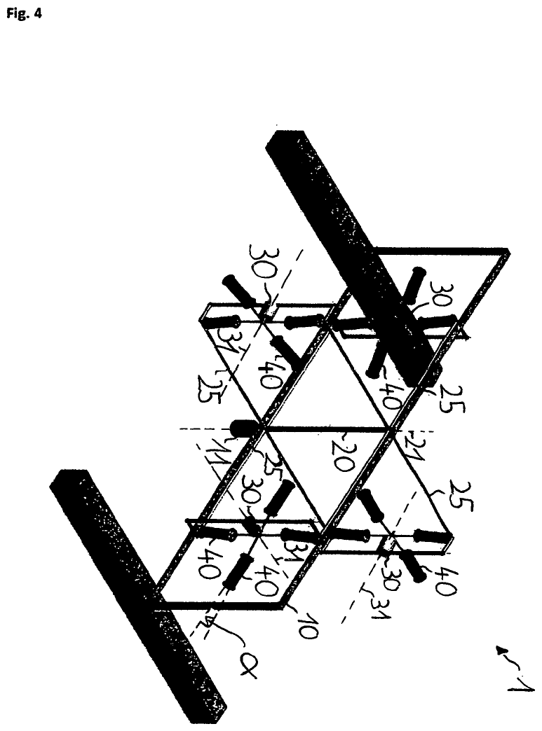

FIG. 4 shows another embodiment of the invention. This variant has a four-winged bogie 25 instead of a two-winged bogie 25 in FIGS. 1 to 3. Further, the description of FIG. 1 can also be read on FIG. 4. Of course 1 single-winged bogies are also possible. The number of rotors can also be varied as required (at least 1 rotor), wherein the distances between the rotors should be sufficient. In contrast to FIGS. 1 to 4, also several rotors 40 can be attached to one rod 35, whereby the term rod is used here only as a synonym for “carrier” in order to avoid confusion with carrier 10. In addition, the invention was explained here only on the basis of a circular path of the second bearings 30. Of course, other path curves are also possible. Another improvement is that the carrier 25 can be profiled or cladded as aerodynamically as possible. In particular as a preferably symmetrical NACA profile.

### REFERENCE CHARACTER LIST

1 device
10 carrier
11 motor
20 drive shaft
21 drive axis
22 tangent
25 bogie
30 second bearing/radial bearing
31 second axis (=axis of rotation)
40 rotor
41 longitudinal axis of the rotor/symmetry axis of the rotor/first axis
α angle
ø angle

1. Device, having at least one rotor
with an axis of symmetry to which the rotor is rotationally symmetrical,
which is driven about its axis of symmetry by means of a motor,
which is mounted rotatably about an axis of rotation which is transverse to the axis of symmetry, so that the rotor, in the event of an incident flow with a fluid, is driven in a rotational movement about the axis of rotation by a force acting transversely to the fluid flow, and
which is translational driven in the fluid relative to the fluid in the longitudinal direction of the axis of rotation.

2. Device according to claim 1
characterized in that
the longitudinal direction of the axis of rotation in the fluid rotates about at least one third axis arranged perpendicular to the axis of rotation in space.

3. Device according to claim 2
characterized in that
the longitudinal direction of the axis of rotation in the fluid rotates about a fixed axis.
